(19) United States
(12) Patent Application Publication
(10) Pub. No.: US 2023/0060907 A1
(43) Pub. Date: Mar. 2, 2023

(54) LOW MOISTURE EXTRUSION PROCESS

(71) Applicant: MARS, INCORPORATED, McLean, VA (US)

(72) Inventors: William GHARIBIAN, Franklin, TN (US); Justin NGUYEN, Franklin, TN (US); Adam WATKINS, Franklin, TN (US); Sjon-Paul CONYER, Franklin, TN (US)

(73) Assignee: MARS, INCORPORATED, McLean, VA (US)

(21) Appl. No.: 17/795,053

(22) PCT Filed: Feb. 10, 2021
(86) PCT No.: PCT/US2021/017471

§ 371 Date: Jul. 25, 2022

Related U.S. Application Data
(60) Provisional application No. 62/972,501, filed on Feb. 10, 2020.

(51) Int. Cl. A23K 40/25; A23K 10/20; A23K 10/30; A23K 50/45; B29C 48/00; B29C 48/295; B29C 48/285; B29C 48/395; B29C 48/86

(52) U.S. Cl. CPC A23K 40/25; A23K 10/20; A23K 10/30; A23K 50/45; B29C 48/022; B29C 48/295; B29C 48/297; B29C 48/395; B29C 48/873

(57) ABSTRACT

A process for making a dry food is described herein. The process includes providing raw materials for a dry food to a preconditioning vessel at a first flowrate, preconditioning the raw materials in the preconditioning vessel and forming a dough, and moving the dough having a moisture content of from about 4% to about 10% through an inlet of an extruder. The process further includes extruding the dough through a die plate of the extruder and forming kibbles by: applying thermal energy to the dough; and applying mechanical energy to the dough, wherein the ratio of the thermal energy to the mechanical energy can range from at least about 2.0 to about 4.0.

### CROSS-REFERENCE TO RELATED APPLICATIONS

This application claims priority to U.S. Patent Application Ser. No. 62/972,501, filed on Feb. 10, 2020, which is incorporated herein by reference in its entirety.

### BACKGROUND

Many food products, including dry pet food products and treats, are prepared by extrusion cooking. Extrusion cooking involves making a composition with raw materials and sequentially passing it through a preconditioner, an extruder and a dryer. The extruded product can be cut or separated into smaller pieces, such as puffs or kibbles.

For conventional systems, raw pet food materials are hydrated, heated and mixed during the preconditioning process to form a dough. Additional liquids, such as oils, fats and colorants can also be added in this preconditioning step. Preconditioners can utilize steam and water at levels sufficient to initiate starch gelatinization while hydrating and mixing the materials.

In such conventional systems, the dough enters an extruder from the discharge of the preconditioner and is pushed through the extruder and forced through a die plate. Additional moisture can be added at this step to further hydrate the dough and control the texture of the final product. Steam can also be added during this process to further cook the dough and/or provide density control. Upon passing the dough through the die plate to form an extrudate, the extrudate usually has large amounts of moisture and needs to be additionally dried by a separate dryer to achieve a kibble that is safe for consumption and stable. The drying process is an energy intensive unit operation and accounts for a large portion of the manufacturing costs and carbon emissions.

Thereby, there exists a need in the art for a process that employs lower amounts of drying energy to reduce or eliminate a need for a dryer.

### SUMMARY

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

To achieve these and other advantages and in accordance with the purpose of the disclosed subject matter, as embodied and broadly described, the disclosed subject matter includes a process for making a dry food, the process including providing raw materials for a dry food to a preconditioning vessel at a first flowrate, preconditioning the raw materials in a vessel and forming a dough, moving the dough having a moisture content of from about 4% to about 10%; through an inlet of an extruder at a second flowrate, extruding the dough through a die plate of the extruder and forming kibbles by applying thermal energy to the dough and applying mechanical energy to the dough, wherein the ratio of the thermal energy to the mechanical energy can range from at least about 2.0 to about 4.0.

In accordance with another aspect of the disclosed subject matter, the method of making a dry food product produces kibbles having moisture content of from about 8% to about 13.5% upon exiting the extruder.

In certain embodiments, the process includes drying the kibbles.

In certain embodiments, the kibble is dried to having a water activity of up to about 0.63.

In certain embodiments, a moisture flash-off after the dough passes through the die is from about 4.0% to about 7.0%.

In certain embodiments, the applying thermal energy to the dough includes using steam.

In certain embodiments, the steam flow is from about 6.0% to about 10.0% of the second flowrate.

In certain embodiments, the steam pressure in the extruder is from about 80 psi to about 150 psi.

In certain embodiments, the thermal energy and the mechanical energy heats the dough past its melting point, thereby decreasing a viscosity of the dough.

In certain embodiments, the first flowrate is from about 0.8 to about 12 tons per hour.

In certain embodiments, the preconditioning further includes adding steam at a rate up to 3% of steam based on the first flowrate.

In certain particular embodiments, the rate of the steam to the preconditioner is 0 tons per hour.

In certain embodiments, preconditioning further includes adding water at a flowrate of up to 4% of the first flowrate.

In certain particular embodiments, the flowrate of water is 0% of the first flowrate.

In certain embodiments, the extruding the dough includes increasing a temperature in the extruder from 30-36° C. to 144-160° C. and increasing a moisture content from 10-12% moisture to 16-18% moisture.

In certain embodiments, a moisture content of the dough in the extruder is from about to about 16% to about 18%.

In certain embodiments, wherein the extruder is one of a single-screw extruder or a twin-screw extruder.

In certain embodiments, after the step of extruding the dough, the kibble is not dried in a dryer.

In certain embodiments, after the step of extruding the dough, the kibble is air-dried.

In certain embodiments, the dough includes from about 10% to about 80% carbohydrate, from about 5% to about 35% fat and from about 5% to about 60% protein.

In certain embodiments the protein includes animal protein.

In certain embodiments, the present disclosure is directed to a process for making a dry food, the process includes providing a dough having a moisture content of from about 4% to about 10%, placing the dough in an extruder at a first flowrate, processing the dough in the extruder, wherein the processing includes applying thermal energy to the dough and applying mechanical energy to the dough, wherein the ratio of the thermal energy to the mechanical energy is at least about 4 and extruding the dough from the extruder through a die plate to form kibbles.

In certain embodiments, the kibbles have a moisture content of from about 8% to 13.5% upon exiting the extruder.

In certain embodiments, the thermal energy and the mechanical energy heat the dough past a melting point of the dough, thereby decreasing a viscosity of the dough.

In certain embodiments, after the step of extruding the dough, the kibble is not dried in a dryer.

In certain embodiments, after the step of extruding the dough, the kibble is air-dried.

In certain embodiments, the dough includes about 10% to about 80% carbohydrate, about 5% to about 35% fat and about 5% to about 60% protein.

In certain embodiments the protein includes animal protein.

### BRIEF DESCRIPTION OF DRAWINGS

The subject matter of the application will be more readily understood from the following detailed description when read in conjunction with the accompanying drawings, in which:

FIG. 1 provides a schematic of an apparatus system used in a conventional process.

FIG. 2 depicts a single-screw extruder used in the low moisture extrusion process according to the disclosed subject matter.

FIG. 3 depicts the cycle of moisture in a conventional extrusion process.

FIG. 4 provides a cycle of moisture in a low moisture extrusion process according to the disclosed subject matter.

FIG. 5 provides a temperature and moisture comparison graph of kibbles created from dough processed through a low moisture extrusion process according to the disclosed subject matter and kibbles created from dough processed through a conventional extrusion process.

FIGS. 6A-C depicts tomographic images of a kibble made by a low moisture extrusion process according to the disclosed subject matter.

FIGS. 6D-E depicts tomographic images of a kibble made by a conventional extrusion process.

FIG. 7A provide images from a microscopic study of composition of kibbles made by low moisture extrusion process according to the disclosed subject matter.

FIG. 7B provide images from a microscopic study of composition of kibbles made an extrusion process.

### DETAILED DESCRIPTION

The present disclosure is directed to a low moisture extrusion (LME) process that uses lower amount of water than conventional extrusion processes, amongst other things.

### Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value. The term “about” in the context of moisture content (wt %) means +/−1 wt %. The term “about” in the context of water activity (Aw) means +/−0.05. The term “about” in the context of final moisture means +/−3%. The term “about” in the context of viscosity means +/−3%.

The terms “animal” or “pet” as used in accordance with the present disclosure refers to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. The term “animal” or “pet” as used in accordance with the present disclosure can further refer to wild animals, including, but not limited to bison, elk, deer, venison, duck, fowl, fish, and the like.

The terms “animal feed,” “animal feed compositions,” “pet food,” “pet food article,” or “pet food composition” are used interchangeably herein and refer to a composition intended for ingestion by an animal or pet. Pet foods can include, without limitation, nutritionally balanced compositions suitable for daily feed, such as kibbles, as well as supplements and/or treats, which can be nutritionally balanced. A nutritionally balanced and complete pet food composition generally will include materials such as proteinaceous materials and/or farinaceous materials. In an alternative embodiment, the supplement and/or treats are not nutritionally balanced.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The term “extruded” in reference to a composition or animal feed refers to a composition or an animal feed which has been processed by, for example, being sent through one or more extruders. Any type of extruder can be used, non-limiting examples of which include single screw extruders and twin-screw extruders, such as but not limited to extruder models Wenger X-115, Wenger X-185, and Wenger X-235.

The term “non-extruded”, as used herein, refers to a food product prepared by any method other than extrusion cooking, such as frying, baking, broiling, grilling, pressure cooking, boiling, ohmic heating, steaming, and the like.

The term “pet treat” refers to a composition intended for ingestion by an animal or pet periodically. Pet treats can be nutritionally balanced. In alternative embodiments, the pet treat is not nutritionally balanced.

As used herein, “kibble” or “dry kibble” refers to an extruded food product with a moisture level less than or equal to 15%, by weight of the food product. A kibble can be nutritionally balanced and complete.

The term “semi-moist”, as used herein refers to a food product with a moisture level between 15% and 50%, by weight of the food product. The term “wet”, as used herein, refers to a food product having a moisture content equal to or greater than 50%, by weight of the food. Semi-moist or wet foods can be prepared at least in part using extrusion cooking or can be prepared entirely by other methods.

As used herein, the term “meal” refers to dry starting materials. Starting materials can include, but are not limited to, proteinaceous materials, farinaceous materials and other materials that do not necessarily fall into either category, including carbohydrates and legumes, such as alfalfa or soy. In certain embodiments that meal includes milled materials. In certain embodiments, the terms “meal” and dry feed can be used interchangeably.

As used herein, the term “proteinaceous materials” include, but are limited to vegetable protein meals, such as soybean, cottonseed, or peanut meals, animal proteins such as casein, albumin, whey, including dried whey, and meat tissue including fresh meat as well as rendered or dried meat “meals” such as fish meal, poultry meal, meat meal, meat and bone meal, enzymatically-treated protein hydrolysates, and the like. Proteinaceous materials can further include microbial protein such as yeast, and other types of protein, including materials such as wheat gluten, corn gluten and feather meal.

As used herein, the term “farinaceous materials” include, but are not limited to, enzymatic farinaceous materials, grains such as corn, maize, wheat, sorghum, barley, and various other grains which are relatively low in protein.

As herein, the term “dough” refers to hydrated meal or dry feed.

As used herein, the term “meal rate” refers to the rate at which meal is fed into a preconditioning vessel. In certain embodiments, the term “meal rate: can refer to the rate at which meal is fed into an extruder.

As used herein, Specific Mechanical Energy (SME) refers to the energy applied to the dough as it is forced through a die plate. SME can be adjusted inadvertently or indirectly to control for process speed or throughput. In certain embodiments, the SME can be increased by increasing the screw speed, or by modifying the screw itself, as by increasing the periodicity of the screw. In a single-screw extruder, useful speed screws can range from 350 rpm or 375 rpm to 600 rpm. Manipulating the SME can contribute to improved texture in at least two ways. First, a higher SME can help break up starch granules, allowing amylose to leach from the starch and amylopectin or other molecules from the starch granules to expand more or more rapidly. Second, a higher SME can help thoroughly mix and hydrate the dough in the final moments before it is forced through the die plate, facilitating starch gelatinization and preparing the dough to expand during extrusion.

As used herein, Specific Thermal Energy (STE) refers to the energy transferred to the meal or dough by all streams entering the preconditioner or extruder and coming into contact with the meal or dough based on their temperature. In the case of steam injection into the preconditioner or extruder, this thermal energy is a function of the steam pressure (enthalpy) and flow rate. In certain embodiments, the STE can be increased by increasing the steam flow rate, or by increasing the steam pressure, or by changing the temperature of the streams entering the preconditioner or extruder. Manipulating the STE can contribute to improved texture. A higher STE can help increase starch cook, allowing amylose to leach from the starch and amylopectin or other molecules from the starch granules to expand more or more rapidly, facilitating starch gelatinization and preparing the dough to expand during extrusion.

### Conventional Extrusion Process

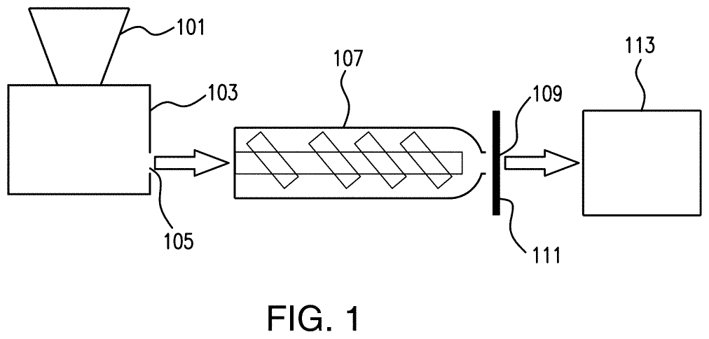

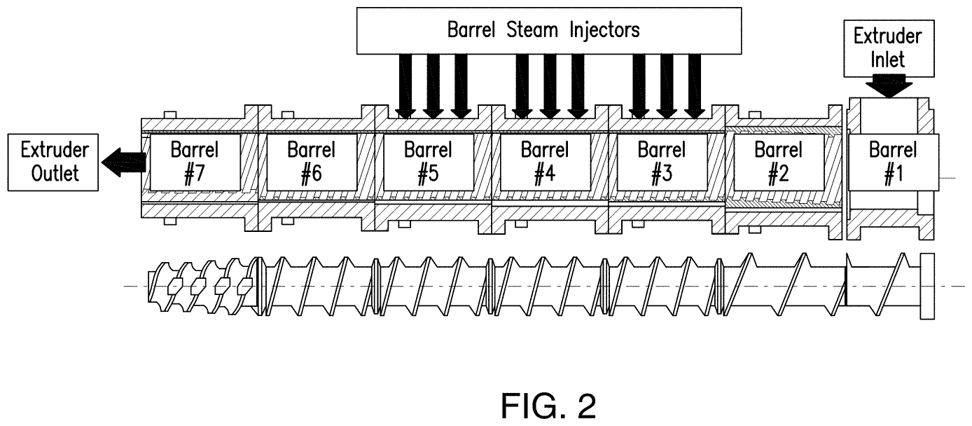

Many food products, including dry pet food products and treats, are prepared by extrusion cooking, which comprises a preconditioning step, an extrusion step and a drying step. Flow of a conventional extrusion process is illustrated in FIG. 1. Raw materials are placed in a preconditioning vessel 103 through a preconditioner inlet 101. During the preconditioning step, the raw materials are mixed with at least one of water and steam in the preconditioning vessel 103 to form a dough composition. Upon completion of the preconditioning step, the composition is moved through a preconditioner exit 105 to an extruder 107. An example extruder is shown in FIG. 2. The extruder has an extruder inlet, seven barrels and an extruder outlet. Steam can be added throughout the extrusion process. During the extrusion step, the dough composition is pushed through a pressure-sealed extruder, where the materials are subjected to high temperatures and pressure. The dough composition is then pushed through an extruder exit 109 through a die 111 to form an extrudate, shaped into kibbles and then sent into a dryer 113.

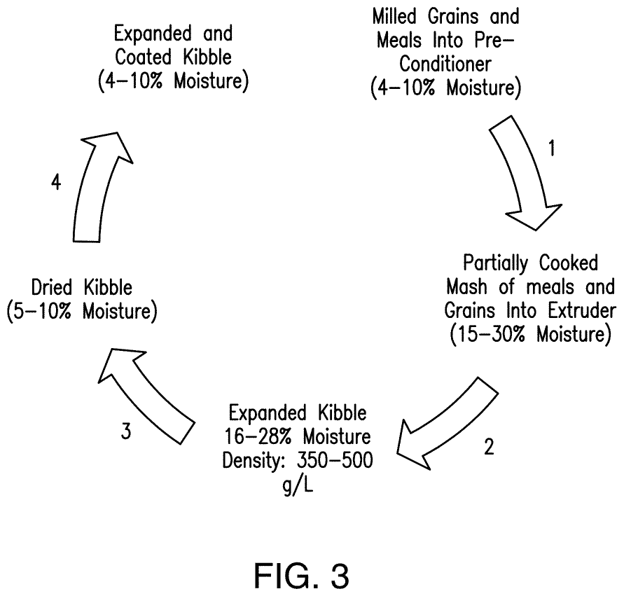

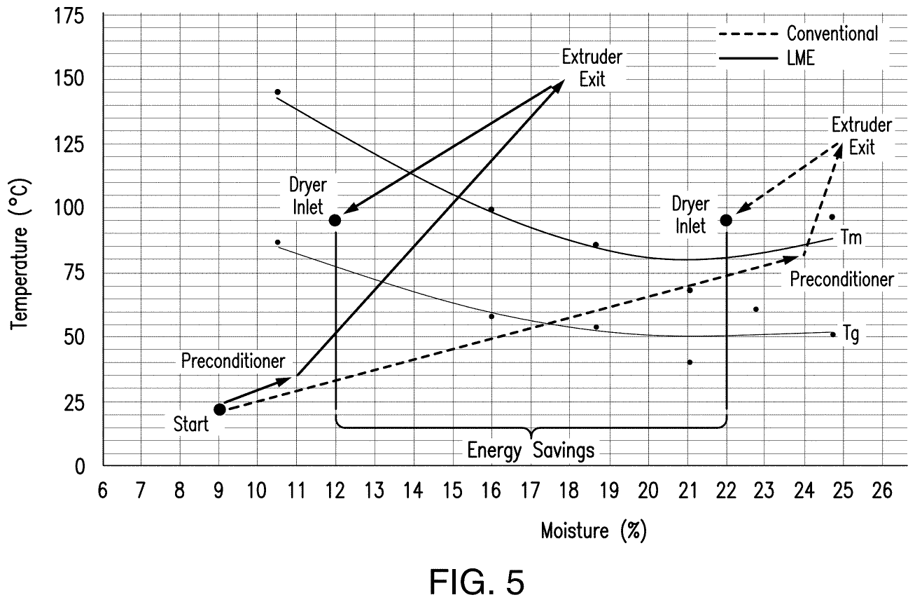

A cycle of moisture in a conventional extrusion process is shown in FIG. 3. During step 1, milled grains and meals are placed into a vessel for preconditioning. The composition initially has about 4-10% of moisture. During a preconditioning process, water is added to provide a composition which has about 22% moisture. The conventional wisdom in the art suggests that moderate moisture levels, such as from about 17% to about 35% are needed to provide a product with desired palatability and texture properties. In certain embodiments, as shown in FIG. 5 and further discussed herein, the preconditioning process for this conventional extrusion process adds about 15% of moisture during the precondition step, resulting in a composition having about 24% of moisture. In certain embodiments process for this conventional extrusion process, the moisture level at the end of the precondition step is from about 19% to about 35%.

During step 2 of FIG. 3, the composition is passed through a pressure-sealed extruder where the materials are subjected to a high temperature and high steam pressure, but at low steam rate. In certain embodiments, the materials are subjected to steam pressure of from about 80 psi to about 150 psi, at a steam rate of up to 4% of meal rate. In certain embodiments, the temperature of the dough is increased from about 54-98° C. to about 119-139° C. inside the extruder.

In certain embodiments, Specific Mechanical Energy of a conventional extrusion process is from about 17.8 to about 36.0 kWh/metric ton. In certain embodiments, Specific Mechanical Energy of a conventional extrusion process is from about 64.2 to about 129.5 kJ/kg.

In certain embodiments, proportion of Specific Thermal Energy to Specific Mechanical Energy in the extruder during a conventional extrusion process is less than about 0.7. In certain embodiments, proportion of Specific Thermal Energy to Specific Mechanical Energy in the extruder during a conventional extrusion process is 0.

After passing through the extruder, the extrudate is cut into pieces to form kibbles. Since the pressure and temperature are higher in the extruder than ambient temperature and pressure, some moisture evaporates by flash-off and the resulting kibbles have from about 16% to about 28% of moisture. As shown in FIG. 3, the material must then be dried in a dryer (step 3) to a food safe moisture level, which depends on the product's water activity. Depending on the product, the final dry pet food product must comprise less than about 15% moisture, less than about 12% moisture, less than about 10% moisture, less than about 8% moisture, or less than about 6% moisture. Therefore, that at least about 10%-25% of water needs to be removed during the drying process. The kibble can then be treated with additional coating, and the final product has about 4-10% of moisture, which is about the same as in the starting materials.

### Low Moisture Extrusion Process

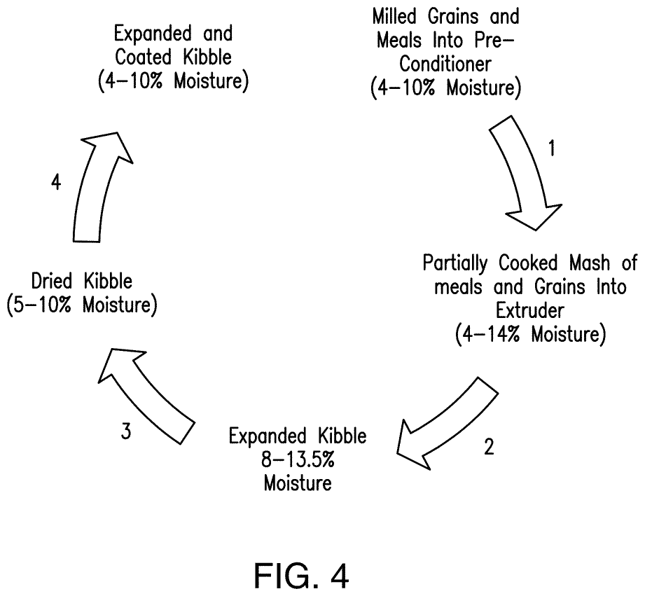

Moisture cycle of the disclosed LME process is shown in FIG. 4. During step 1, milled grains and meals are placed into a vessel for preconditioning. The composition initially has about 4-10% of moisture. During a preconditioning process, low amounts of water is added, and the resulting composition has from about 4% to about 15% of moisture. During step 2, the composition is passed through an extruder at a high temperature and pressure and high rate of steam. After passing through the extruder and through a die, some moisture evaporates due to flash-off and the moisture level of the composition is about from about 8% to about 14%. Since the temperature and pressure is higher inside the extruder for the LME process as compared to extrusion process, larger proportion of moisture is lost during flash off, resulting in kibbles that need little to no drying. The excess moisture is then removed during optional step 3 (drying) and resulting in a dried kibble that has the moisture level of about 5-10%. The kibble can then be treated with additional coating, and the final product has about 4-10% of moisture. This moisture level is about the same as it is in the starting materials.

An LME manufactured kibble, like conventionally manufactured kibble, can be a nutritionally complete and balanced animal diet which provides all essential nutrients to sustain life (with the exception of water). Nutritionally complete and balanced pet food products can meet consensus nutrient profiles, such as AAFCO standards for dog or cat food, and can achieve such nutrient profiles with formulations that include proteinaceous, farinaceous and other materials. In some embodiments, the presently-disclosed extruded kibble is manufactured from a dough that includes about 10% to about 80% carbohydrate, about 5% to about 35% fat and about 5% to about 60% protein. In some embodiments a dough comprises about 5% to about 60% animal protein. In some embodiments, a dough, and the resulting kibble, can comprise additional ingredients including, without limitation, such as vitamins, minerals, colorants, flavorants, and the like.

The LME process according to the disclosed subject matter overcomes the issues outlined above in conventional systems. The LME process according to the disclosed subject matter is described in more detail below.

### Preconditioning

Prior to processing pet food materials through the LME process, the food materials can be preconditioned in a preconditioning step. A preconditioner begins the cooking process of raw materials prior to entering the extruder. A dough or the materials for a dough can be mixed in the preconditioner with steam and/or water under controlled conditions to precook or preheat the dough, to mix all materials into the dough, and/or to prepare the dough (as by hydration) for the desired conditions during extrusion cooking. Additional liquids can be added here including oils/fats and color. Preconditioners can utilize high steam and water flow rates to begin the gelatinization process while hydrating and mixing the material. However, this process is rather energy inefficient, as preconditioners, unlike extruders, are not pressure sealed and can vent steam and heat (i.e., energy) into the atmosphere.

Moisture level at this preconditioning step is set to low levels to minimize the amount of water used during the manufacturing process as well as the amount of drying required after extrusion cooking. In certain embodiments, the composition out of the preconditioner exit has moisture of from about 10% to about 14% based on weight. While conventional processes usually start gelatinization during the precondition step, it was surprisingly found that the initial gelatinization can be delayed until the extrusion step. In some embodiments, it was surprisingly found that moisture levels and gelatinization in the preconditioning step could be reduced while achieving final kibbles having texture properties comparable to those of kibbles made by a conventional process. In certain embodiments according to the disclosed subject matter, less than 5%, less than 4%, less than 3%, less than 2% or less than 1%, of moisture is added during preconditioning based on meal rate when LME process is utilized. In certain embodiments according to the disclosed subject matter, steam is not added during the preconditioning step, unlike conventional processes. However, in certain embodiments according to the disclosed subject matter, low stream pressure, e. g., from about 15 psi to about 60 is used during the preconditioning step when using the LME process. Furthermore, in certain non-limiting embodiments, as shown in FIG. 5, less than 1% of moisture is added during preconditioning step when LME process are utilized, and no steam is used. Importantly, this LME based process provides more efficient heat transfer and thermal energy input, since preconditioners, unlike extruders, are not pressure sealed and can vent steam and heat (i.e., energy) into the atmosphere. Additionally, since a low amount of moisture is as added at this preconditioning step when using the LME process, lower water flow rates can be used. The operational differences between precondition step in the disclosed LME process versus the conventional extrusion process are illustrated in Table 1.1.

TABLE 1.1
Comparison of Operational Differences between
LME and Conventional Extrusion Process

| | Conv. Extrusion Process | LME Process |
|---|---|---|
| Water Flow Needed | High Rates | Low Rates |
| Steam Flow Needed | High Rates | Low Rates |
| Steam Pressure | ~30 psi | ~30 psi |

In certain embodiments, a conventional extrusion process employs high rates of water flow, e.g., from about 10% to about 22%, based on meal rate during preconditioning. In certain embodiments, a conventional extrusion process employs high rates of steam flow, e.g., from about 5% to about 13%, based on meal rate during preconditioning. In certain embodiments, a conventional extrusion process employs low steam pressure, e.g., from about 15 psi to about 60 psi.

In certain embodiments, an LME process employs low rates of water flow, e.g., up to 4%, based on meal rate during preconditioning. In certain embodiments, no water is added during preconditioning. In certain embodiments, an LME process employs low rates of steam flow, e.g., up to 3% or up to 4%, based on meal rate during preconditioning. In certain embodiments, no steam is added during preconditioning. In certain embodiments, an LME process employs low steam pressure, e.g., from about 15 psi to about 60 psi.

The dough from the preconditioning process discharges from the preconditioner and enters the extruder. Here, the dough is pushed through the extruder towards a die to form an extrudate and is further shaped by the die into kibbles. Dyes, oils, water, and steam can be added into the extruder during this stage. The extruder, such as but not limited to a single-screw extruder or a twin-screw extruder, applies high temperature, pressure, and shear to induce gelatinization of starch molecules. An example extruder that can be used with the LME process is provided in FIG. 2.

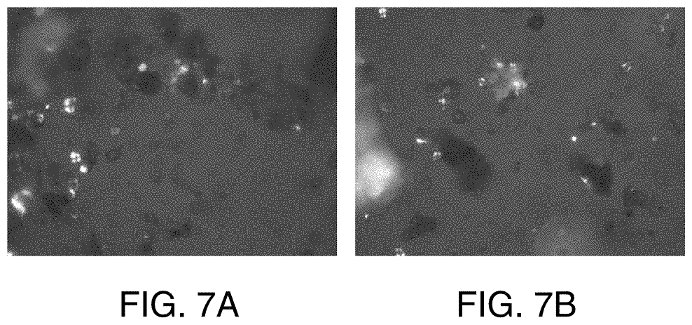

As shown in FIGS. 7A and 7B, it was found that if the initial gelatinization of starch molecules is delayed until extrusion process and the extrusion process is performed with dough having reduced moisture levels when compared to conventional processes, the amount of uncooked starch in a final kibble product is approximately the same as for kibble manufactured by conventional processes. Additionally, while it is generally believed that adding moisture and starting the process of starch gelatinization during the preconditioning step lowers the Specific Mechanical Energy (SME) required in the extruder, in some embodiments it was found that extruder SME remained substantially the same as SME of conventional processes. Without being bound by theory or mechanism, the SME was substantially the same in LME and conventional processes because LME extruder temperatures can be past the melting point of the dough in the extruder, thereby lowering the viscosity of the dough material.

Additional studies were run to compare starch gelatinization ranges between conventional and LME process. The studies showed that the difference was not statistically significant. For example, both processes produce finished product gel ratio in the range of 77-100% using the NIR method and between 81-100% using the wet chemistry method. As such, the SME of the process disclosed herein is still comparable to or can be even lower than the conventional process. Certain embodiments according to the disclosed embodiments do not need to utilize an extruder with a higher horsepower motor to generate the same kibbles as a conventional system. In certain embodiments, an extruder has power of from about 300 to about 500 horsepower.

Specific Mechanical Energy can be varied during extrusion process by varying a rate of screw. In certain embodiments, the screw rate of an extrusion process can be from about 283 rpm to about 450 rpm, from about 320 rpm to about 420 rpm, or from about 240 rpm to about 263 rpm.

Table 1.2 shows further comparisons of product made from the conventional extrusion process and from the LME process. In certain embodiments for the LME processing, the dough is extruded with an SME of at least about 56.3 kJ/kg and can range between about 50 kJ/kg to about 100 kJ/kg, which is generally lower than the SME of dough extruded in the conventional extrusion process as shown in Table 1.2 below.

TABLE 1.2
Comparison between LME and Conventional Extrusion Process

| | | Conventional | |
|---|---|---|---|
| | | Extrusion | |
| Parameter | Units | Process | LME Process |
| Moisture Flash Off | (%) | <4.0 | 4.0-7.0 |
| Moisture | (%) | 10.3-19.7 | 25.2-31.2 |
| Percentage Change | | | |
| after Flash Off | | | |
| *STE:SME | (ratio) | 0.0-0.7 | 2.0-3.9 |
| in Extruder | | | |
| SME | (kWh/Metric Ton) | 17.8-36.0 | 14.1-27.8 |
| | (kJ/kg) | 64.2-129.5 | 50.7-100.0 |

*Negating thermal energy coming from raw materials (dry and liquid) and only using steam going into the extruder as thermal energy

Moisture Percentage Change after Flash Off is calculated as:

$$\frac{Moisture in Extruder - Moisture after Flash Off}{M o i sture in Extruder} \times 100$$

Thermal energy is provided during the extrusion process by, for example, direct steam injection during processing, and can be quantified by a Specific Thermal Energy (STE). The added steam during the extrusion process also adds moisture to the dough. In certain embodiments, the composition has from about 16% to about 18% of moisture before moving through the die. In certain embodiments, as shown in FIG. 5, the extrudate has about 18% of moisture before the die when made by LME process, compared to about 25%, when made by an extrusion process.

The ratio of STE and SME during the LME process (excluding preconditioning step) can range from about 2.0 to about 4.0, as provided in Table 1.2. This is in direct contrast with the ratio of STE and SME during the conventional extrusion process, which can range from about 0 to about 0.7 as noted in Table 1.2.

The cooked dough is forced through shaped dies as extrudate and is cut. During this step, the extrudate expands due to temperature and pressure differences between extruder and the immediate external environment. Importantly, the temperature of extrudate before the die is much higher than its melting temperature Tm. This drives more flash off i.e., moisture loss in the form of steam caused by the difference between ambient temperature of the external environment and temperature within the extruder, as further explained with respect to FIG. 5 herein. As shown in the example of Table 1.2, moisture flash off is shown for a conventional and LME process example. The moisture flash off percentage represents the moisture in the extruder less the moisture after flash off. For conventional extrusion process, the moisture flash off can range up to 4.0%. In contrast, for the LME process, the moisture flash off can range from about 4.0% to about 7.0%, which is a much higher flash off than the conventional process. Accordingly, the corresponding moisture percentage change after flash off for the conventional extrusion process, the flash off percentages can range from about 10.3% to about 19.7%. In contrast, moisture percentage change after flash off for the LME process can range from about 25.2% to 31.2%, which is much greater than the flash off percentages for the conventional extrusion process.

FIG. 5 provides a temperature and moisture comparison graph of kibbles created from dough processed through the LME process according to the disclosed subject matter (represented by the solid line) and kibbles created from dough processed through a conventional extrusion process (represented by the dashed line). As evident on FIG. 5 for the LME process, the temperature at which the raw materials enter the preconditioner vessel is approximately 20° C. and the temperature at which the dough exits the preconditioning vessel is approximately 30-36° C. As referenced in FIG. 5 for LME process and discussed herein, high-pressure steam and mechanical energy is added to the dough in the extruder and the temperature of the dough increases from about 30-35° C. to about 150° C. just prior to the exit of the dough from the extruder. In certain embodiments, the temperature of the dough just prior to the exit of the dough from the extruder is from about 144° C. to about 160° C. With respect to FIG. 5, with the increasing temperature of the dough for the LME process, the dough reaches various stages in the extruder beginning with the onset of protein denaturation (at approximately 55° C.), onset of starch gelatinization (at approximately 60° C.), and killing certain bacteria such as salmonella (at approximately 70 to 80° C.). Furthermore, the increasing temperature of the dough for the LME process reaches its glass transition temperature (represented by line Tg) and melting point temperature (represented by line Tm) within the extruder during the LME process (and not in the preconditioning vessel as shown by the conventional example of FIG. 5). Interestingly, the moisture content percentage of the dough upon entry into the extruder for the LME process is about 10 to 11% and the moisture content percentage of the dough prior to exit is approximately 18% in this example. Post exiting the extruder, the moisture content percentage flashes off and decreases to approximately 12%.

As can be further seen in FIG. 5, in this example, the LME process according to the disclosed subject matter reduced moisture of the kibble by 10% in comparison with the conventional process before drying. Since the resulting kibble has a lower moisture content than the kibble from the conventional process, less drying is needed for the resulting kibble, therefore significantly reducing energy requirements for the entire process. In certain embodiments, LME process uses at least about 30% less energy than a conventional process. In certain embodiments, the kibble can be dried to having a water activity of up to about 0.63 after drying. In some embodiments, after flash-off, a kibble manufactured by a LME process has sufficiently low moisture levels to achieve a water activity of about 0.63 or less without the need for an active drying step (e.g., passing kibble through dryer).

In contrast, the conventional process example (shown in the dashed lines) in FIG. 5 utilizes water and low-pressure steam in the preconditioning vessel for the protein denaturation, starch gelatinization, and bacteria killing, unlike the LME process which accomplishes these thresholds in the extruder. The dough in the conventional process further reaches its glass transition temperature in the preconditioning vessel, as depicted in FIG. 5. For the conventional process, the dough at exit of the preconditioning vessel and at the entry of the extruder has about 24% moisture content and has reached approximately 80° C. The dough in extruder of the conventional process is subject to high-pressure steam and mechanical energy as noted above, and the dough prior to exiting the extruder has a moisture content of approximately 25% and a temperature of approximately 125° C. The flash off of the dough post exiting the extruder causes the dough to decrease to approximately 22% moisture content. As shown in FIG. 5, the LME process offers an energy savings in comparison with the conventional process.

The operational differences between extrusion step in the disclosed LME process versus the conventional extrusion process are illustrated below in Table 2.

TABLE 2
Comparison of Operational Differences
between LME and Extrusion Process

| | Conv. Extrusion Process | LME |
|---|---|---|
| Water Flow Needed | Low Rates | Low Rates |
| Steam Flow Needed | Low Rates | High Rates |
| Steam Pressure | ~100 psi | ~100 psi |

In certain embodiments, a conventional extrusion process employs low rates of water flow, e.g., up to about 2% based on meal rate. In certain embodiments, a conventional extrusion process employs low rates of steam flow, e.g., up to 4% based on meal rate. In certain embodiments, a conventional extrusion process employs high steam pressure, e.g., from about 80 psi to about 150 psi.

In certain embodiments, an LME process employs low rates of water flow, e.g., up to about 2% based on meal rate. In certain embodiments, an LME process employs high rates of steam flow, e.g., from about 6% to about 10% based on meal rate. In certain embodiments, an LME process employs high steam pressure, e.g., from about 80 psi to about 150 psi.

### EXAMPLES

The following examples are merely illustrative of the presently disclosed subject matter and they should not be considered as limiting the scope of the subject matter in any way.

### Example 1: LME Process

Example 1 provides a process for preparing pet food kibbles by the LME process.

Powder/meal of raw materials for the kibble are mixed in a precondition vessel. Initial moisture content of the composition is about 10%. Low rate of steam, such as from about 3% to about 14% of the meal rate, at pressure of about 30 psi is added. Low water rates are applied to the mixture, such as from about 1% to about 14% of meal rate. The preconditioning step adds about 3% of moisture to the starting materials forming a dough, based on meal rate. The process parameters of preconditioning step are shown in Table 3.

TABLE 3
Process Parameters of Preconditioning Step

| Process | | | |
|---|---|---|---|
| parameter | Design range | Precision | Method |
| Powder/Meal | 6-10 tons | ≤±3% @3σ | Loss in weight |
| Flowrate | per hour | | |
| Water Flowrate | 1%-14% of | ≤±1% @ 3σ | Coriolis mass |
| | Meal Rate | | flow meter |
| Steam Flowrate | 3%-14% of | ≤±1% @ 3σ | Flow meter |
| | Meal Rate | | |
| Poultry Fat, | 0%-2% of | ≤±1% @ 3σ | Coriolis mass |
| Tallow or Oil | Meal Rate | | flow meter |
| Flowrate | | | |
| Steam Pressure | 30 psig at | | Pressure gauge |
| | manifold or | | or pressure |
| | upstream | | transducer |

The dough enters the extruder from the discharge exit of the preconditioner. In alternate embodiments, it is contemplated that the dough can be disposed into the extruder by an intermediary hopper or the like if the preconditioner is located separate from the extruder. In this example, the extruder is a 7-head machine with barrel 1 being the inlet barrel, as shown in FIG. 2. The single-screw extruder applies high temperature, pressure, and shear to induce gelatinization of starch molecules. The steam adds about 6.5% of moisture to the mixture, based on meal rate. The process heats the mashed dough beyond its melting point which in turn decreases the material's viscosity. The material is forced through shaped dies and cut into kibbles resulting in expansion, due to temperature and pressure differences between extruder and environment. The process parameters of preconditioning step are shown in Table 4.

TABLE 4
Process Parameters of Extrusion Step

| Process | | | |
|---|---|---|---|
| parameter | Design range | Precision | Method |
| Extruder Type | Wenger Single- | X-115 thru | |
| | Screw Extruder | X-235 | |
| | or equivalent | | |
| Color Pulsing | 0%-2% of Meal | Accuracy: ≤±1% | Coriolis Mass |
| | Rate | @ 3 σ | Flow Meter |
| Barrel Steam | 1.0%-10.0% of | Accuracy: ≤±1% | Mass Flow |
| Flowrate | Meal Rate | @ 3σ | Meter |
| (steam | | | |
| injectors) | | | |
| Barrel Steam | 100-120 psig @ | | Pressure Gauge |
| Pressure | Manifold or | | or Transducer |
| (steam | Upstream | | |
| injectors) | | | |
| Screw Speed | 240-450 rpm | | |
| Steam Injectors | Min. 3 Injectors | | Injector Nozzles |
| | per Barrel in | | with Individual |
| | Barrels 3, 4, | | Shut-Off Valves |
| | and 5 | | |

The kibbles are then dried to drive moisture off the kibble's surface and from the kibble's core. This step can be beneficial for mold prevention and storage stability in ambient conditions. Process parameters of the drying step are shown in Table 5.

TABLE 5
Process Parameters of Drying Step

| Process | | | |
|---|---|---|---|
| parameter* | Design range | Precision | Method |
| Incoming Product | 70-95° C. | | Temperature |
| Temperature | | | measuring |
| | | | device |
| Incoming Product | 12-23% | | Moisture |
| Moisture | | | Oven |
| | | | Balance |
| Incoming Product | 7-12 tons | Accuracy: ≤±3% | Mass Balance |
| Rate | per hour | @ 3σ | |
| Outlet Product | 43-65° C. | | Temperature |
| Temperature | | | measuring |
| | | | device |
| Outlet Product | ~8% | | NIR |
| Moisture | | | |

### Example 2: Conventional Example

Example 2 provides a process for preparing pet food kibbles by a conventional extrusion process.

Powder/meal of raw materials for the kibble are mixed in a precondition vessel. Initial moisture of the composition is about 10%. A high rate of steam, e.g., up to about 13% of meal rate at pressure of about 30 psi is added. High water rates are applied to the mixture e.g., up to 22% based on meal rate. The preconditioning step adds about 10% of moisture to the starting materials due to the water and additional about 10% of moisture due to the steam, forming a dough, based on meal rate.

The dough enters the extruder from the discharge of the preconditioner. The extruder is a 7-head machine with barrel 1 being the inlet barrel, as shown in FIG. 2. The single-screw extruder applies high temperature, pressure, and shear to continue gelatinization of starch molecules. The material is forced through shaped dies and cut into kibbles resulting in expansion due to temperature and pressure differences between extruder and environment.

The kibbles are then dried in a dryer to drive moisture off the kibble's surface and from the kibble's core.

### Example 3: Comparison of Kibbles Made by LME and Conventional Process

Example 3 provides various comparative tests performed to compare kibble made by LME and by the conventional process.

### Extrusion Mass and Energy Balance

Extrusion mass and energy balance for processes described in Example 1 and Example 2 are shown in Table 6. Example 1 was formed by the LME process according to the disclosed subject matter and Example 2 was formed by the conventional process.

Table 6 provides an exemplifying extrusion mass and energy balance comparison for the disclosed LME process and the conventional extrusion process.

TABLE 6

| | | Example 1- |
|---|---|---|
| Extrusion Mass & Energy Balance | Example 2 | LME |
| Meal Rate (kg/hr) | 800 | 800 |
| Preconditioning Water Rate (kg/hr) | 112 | 24 |
| Preconditioning Steam Rate (kg/hr) | 72 | 0 |
| Extrusion Steam Rate (kg/hr) | 0 | 64 |
| Extrusion Water Rate (kg/hr) | 0 | 0 |
| Specific Mechanical Energy-SME (kJ/kg) | 74.8 | 56.3 |
| Specific Thermal Energy-STE (kJ/kg) | 246.9 | 242.6 |
| Specific Total Energy-STotalE (kJ/kg) | 321.7 | 298.9 |
| Temperature of Extrudate Behind the Die (° C.) | 125 | 145 |
| Mass Fraction of Moisture in Extruder (%) | 28.6 | 20.9 |

As shown in Table 6, STE is similar between the conventional extrusion process and the disclosed LME process, as the steam system is shifted from preconditioning step to extrusion step in the LME process. Additionally, SME is similar (and even lower) for the LME process due to extrusion process as disclosed. This can be explained by the composition having a lower viscosity at higher temperatures in the LME process.

### X-Ray Tomography

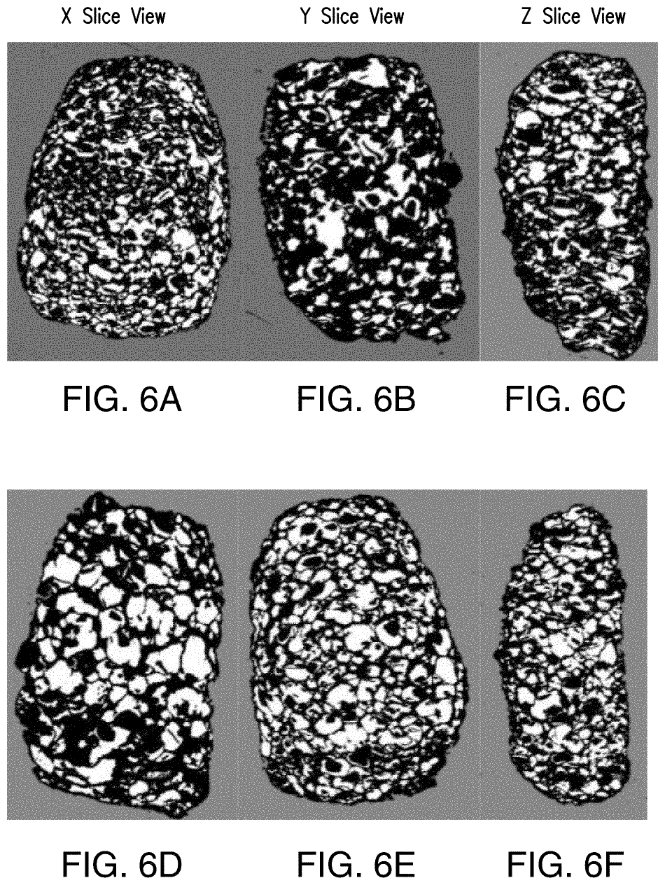

A pet food kibble from Example 1 and a pet food kibble of Example 2 were examined by X-Ray Tomography, as shown in FIGS. 6A-E as further discussed herein. Example 1 was formed by the LME process according to the disclosed subject matter and Example 2 was formed by the conventional process. Each sample was examined using NSI ImagiX X-Ray Tomography system. The samples were prepared for analysis by fixing the centers into a paper thimble using pieces of styrofoam. The thimble containing the sample was then placed into a 50 ml polypropylene tube. Tomographic slice views of the samples were taken in the X, Y, and Z planes, as shown in FIGS. 6A-E and as further discussed herein. The polypropylene tube was taped to the x-ray tomography holder. ImageJ software was used to measure aeration. The results from aeration analysis are summarized in Table 7.

TABLE 7
Aeration of Samples

| | Tomographic | Aeration Area | Total Area | % Air in |
|---|---|---|---|---|
| Sample | Slice View | in Slice | in Slice | slice |
| Example 1 | X Slice | 112499 | 312232 | 36 |
| | Y Slice | 83336 | 301939 | 28 |
| | Z Slice | 67664 | 211701 | 32 |
| Average | | 87833 | 275291 | 32 |
| Example 2 | X Slice | 156068 | 409058 | 38 |
| (Comparative | Y Slice | 179329 | 424546 | 42 |
| Example) | Z Slice | 88757 | 229940 | 39 |
| Average | | 141385 | 354515 | 40 |

The results from Table 7 show that the kibble form Example 1 had about 32% of aeration, while the kibble of Example 2 had about 40%.

FIGS. 6A-E further illustrate the differences in aeration of the two kibbles by showing Tomographic slice views. Aeration is shown by the white areas. It is shown that the slices depicted in FIGS. 6A-C, which correspond to the kibble of Example 1, have fewer white areas, and therefore less aeration than the comparative kibble depicted in FIGS. 6D-F. However, the air bubbles in the kibble of Example 1 are smaller than those for the Example 2. Additionally, the air bubbles in the kibble of Example 1 are elongated in shape, while those of the Example 2 are spherical.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

1. A process for making a dry food, the process comprising:
(a) providing raw materials for a dry food to a preconditioning vessel at a first flowrate;
(b) preconditioning the raw materials in the preconditioning vessel and forming a dough;
(c) moving the dough having a moisture content of from about 4% to about 10% through an inlet of an extruder; and
(d) extruding the dough through a die plate of the extruder and forming kibbles by:
(i) applying thermal energy to the dough; and
(ii) applying mechanical energy to the dough,
wherein the ratio of the thermal energy to the mechanical energy can range from at least about 2.0 to about 4.0.

2. The process of claim 1, wherein the kibbles have moisture content of from about 8% to about 13.5% upon exiting the extruder.

3. (canceled)

4. The process of claim 3, wherein the kibble is dried to having a water activity of up to about 0.63.

5. The process of claim 1, wherein a moisture flash-off after the dough passes through the die is from about 4.0% to about 7.0%.

6. The process of claim 1, wherein the applying thermal energy to the dough comprises using steam.

7. The process of claim 6, wherein a flow of the steam is from about 6.0% to about 10.0% of the first flowrate.

8. The process of claim 6, wherein a pressure of the steam is from about 80 psi to about 150 psi.

9. (canceled)

10. The process of claim 1, wherein the first flowrate is from about 0.8 to about 12 tons per hour.

11. The process of claim 1, wherein the preconditioning further comprises adding steam at a rate up to 3% of steam based on the first flowrate.

12. (canceled)

13. The process of claim 1, wherein preconditioning further comprises adding water at a flowrate of up to 4% of the first flowrate.

14. (canceled)

15. The process of claim 1, wherein the extruding the dough comprises increasing a temperature in the extruder from 30-36° C. to 144-160° C. and increasing a moisture content from 10-12% moisture to 16-18% moisture.

16. (canceled)

17. (canceled)

18. (canceled)

19. The process of claim 1, wherein, after the step of extruding the dough, the kibble is not dried in a dryer.

20. The process of claim 1, wherein the dough comprises from about 10% to about 80% carbohydrate, from about 5% to about 35% fat and from about 5% to about 60% protein.

21. (canceled)

22. A process for making a dry food, the process comprising:
(a) providing a dough having a moisture content of from about 4% to about 10%;
(b) placing the dough in an extruder at a first flowrate;
(c) processing the dough in the extruder, wherein the processing comprises:
(i) applying thermal energy to the dough; and
(ii) applying mechanical energy to the dough,
wherein the ratio of the thermal energy to the mechanical energy is at least about 4; and
(d) extruding the dough from the extruder through a die plate to form kibbles.

23. The process of claim 22, wherein the kibbles have a moisture content of from about 8% to 13.5% upon exiting the extruder.

24. The process of claim 22, wherein the thermal energy and the mechanical energy heat the dough past a melting point of the dough, thereby decreasing a viscosity of the dough.

25. The process of claim 22, wherein, after the step of extruding the dough, the kibble is not dried in a dryer.

26. The process of claim 22, wherein the dough comprises from about 10% to about 80% carbohydrate, from about 5% to about 35% fat and from about 5% to about 60% protein.

27. The process of claim 26, wherein the protein comprises animal protein.
